(19) United States
(12) Patent Application Publication
(10) Pub. No.: US 2014/0137044 A1
(43) Pub. Date: May 15, 2014

(54) PROGRAMMABLE FOOD COOKING APPLIANCE HAVING A DISPLAY

(71) Applicant: Technology Licensing Corporation, Fort Lauderdale, FL (US)

(72) Inventors: George F. Koether, Southport, CT (US); Stan Vreeland, Beacon Falls, CT (US); Edward J. Musial, Milford, CT (US)

(73) Assignee: Technology Licensing Corporation, Stratford, CT (US)

(21) Appl. No.: 14/078,957

(22) Filed: Nov. 13, 2013

Related U.S. Application Data
(60) Provisional application No. 61/726,063, filed on Nov. 14, 2012.

(51) Int. Cl. A47J 27/62; G06F 3/0482

(52) U.S. Cl. CPC A47J 27/62; G06F 3/0482
USPC 715/835; 99/325

(57) ABSTRACT

A programmable food cooking appliance having a display includes a control panel. One or more control buttons for controlling operation of the food cooking appliance are disposed on the control panel. One or more displays, each one of the two or more displays are disposed on the control panel adjacent a respective control button. A database stores two or more recipes. A processor communicates with the database and assigns a recipe to a respective one of each control button, and transmits a display signal to the display adjacent the respective one control button to display a description of the recipe associated with the respective one control button.

### CROSS REFERENCE TO RELATED APPLICATION(S)

This application claims the benefit of Provisional Patent Application No. 61/726,063, filed Nov. 14, 2013, the contents of which are incorporated herein.

### BACKGROUND OF THE INVENTION

The present invention is directed to a programmable kitchen appliance capable of cooking a variety of foods, and in particular, a programmable kitchen appliance having a multiplicity of control buttons with corresponding labeling for indicating a function of the buttons.

It is known in the art, particularly in a commercial kitchen setting, for a cooking device, such as a fryer or oven by way of example, to automatically process an entire recipe for preparing food. Furthermore, it is known in the art to maximize the use of the cooking apparatus by utilizing the cooking apparatus for a variety of foods, each having a different recipe. By way of example, a fryer may be utilized to cook hash browns in the morning, chicken in the afternoon, and fish and ribs in the evening or perhaps all of these at any point in the day. Each of these foods has its own individual recipe defined for the purpose herein as the settings required to obtain the proper cooking, including but not limited to time, temperature, pressure, and other factors depending upon the appliance type.

A cooking appliance has one or more control buttons for initiating the performance of a recipe by the food cooking appliance. Within the restaurant environment, there have traditionally been two methods for identifying the food item associated with the appropriate control button. The first method is the use of labels such as hand written or pre-printed stickers that are applied on or adjacent to the control button to identify for the operator which button to press to cook a given item in accordance with an appropriate recipe. Accordingly, the user may print the word chicken onto a sticker and place the sticker adjacent button corresponding to the time temperature control parameters for the fryer to fry chicken. A second sticker may be applied on a second button to control cooking of french fries.

This approach has proved satisfactory as fryers and other cooking appliances became more complex. However, they suffered from the deficiency that over time, labels fade or fall off due to constant contact. Furthermore, as a result of operator error, when a recipe associated with a particular control button is changed, the label was not always changed, resulting in misoperation of the device, which in the case of food, can lead to waste as a result of improper cooking or even a health hazard if under cooking of certain food occurs.

To overcome this shortcoming, it has become known in the art to use an electronic display to display the recipe of a selected control button. By way of example, a display may share a recipe name corresponding to more than one particular button, or even a scroll type of display may be associated with a series of buttons, so an LED display may exhibit french fries. However, because of limitation in space and technology, only a single display is present, slaved to all of the buttons, so only the display message corresponding to the currently selected button is displayed. Therefore, the operator is required to press every button in order to determine which button corresponds to the desired recipe as the single display displays the associated recipe for each button as it is activated. Furthermore, as a result of the need to press the button for the recipe to be displayed, operation of the device may occur when the operator is selecting the buttons if they inadvertently initiate an unwanted operation while searching for the button corresponding to the desired operation.

There are also systems which automatically configure the recipe associated with a button as known from U.S. Published Patent Application No. 2009/0092723 However, this automatic menu switching occurs at predetermined times when switching from one type of menu such as breakfast, to another, such as lunch or dinner. Compounding the shortcomings of the prior art, during the course of the day, each button may be controlling two or more recipes as a function of a change in menu or time of day. These different menus are shown in limited fashion as described above in connection with the prior art, either with changing cards, or an additional item for the single display, adding to the complexity in what each operator must remember.

One prior art solution to these shortcomings has been to utilize touch screen controllers similar to what one might see in smart phone technologies where the user can scroll through pictures or words of products to select the desired recipe they wish to cook; in other words as ingle display acts as all of the buttons. The disadvantage of this technology is both cost as well as throughput. Quick Service Restaurants (QSR) are driven by maximizing process flow and productivity. Furthermore, as the number of recipes increases, the size of each icon shrinks or the scroll list grows, to allow display on two or fewer screens, making the touch screen hard to read or susceptible to “fat thumb” pressing of an unintended icon. As such the QSR Industry prefers a single physical button press to initiate a cooking cycle for which the touch screen devices are inappropriate.

Accordingly, a system for identifying a recipe associated with a single button which overcomes the shortcomings of the prior art is desired.

### BRIEF SUMMARY OF THE INVENTION

A food preparation appliance includes a control panel. A plurality of physical control buttons for controlling operation of the appliance are disposed on the display panel. A plurality of displays, adjacent and associated with a respective one of the control buttons is provided at the display panel. A processor is in communication with a data base; a plurality of recipes being stored in the data base. The processor assigns a recipe to a respective one of each control button and outputs a display signal to the respective display of each control button to display a description of the recipe associated with the respective button. An input/output device communicates with the processor to provide control signals for determining the recipe to be associated with a respective control button and the display signal to be input to the display associated with each control button.

### BRIEF DESCRIPTION OF THE DRAWINGS

The present disclosure is better understood by reading the written description with reference to the accompanying drawing figures in which the reference numerals denote the similar structure and refer to the elements throughout in which:

FIG. 1 is a schematic view of a food cooking apparatus constructed in accordance with the invention;

FIG. 2 is a display panel for a food cooking apparatus constructed in accordance with the invention showing a different display; and

FIG. 3 is a flow chart for the operation of the control panel in accordance with the invention.

### DETAILED DESCRIPTION OF THE PREFERRED EMBODIMENT

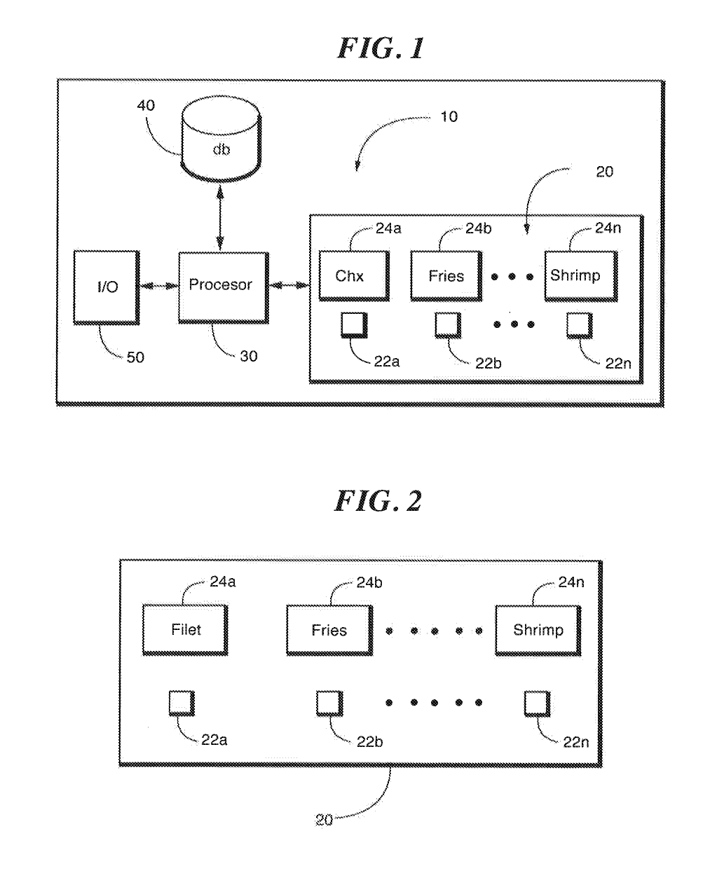

As seen in FIG. 1, a control panel 20 resides on or is adjacent to a cooking appliance. A plurality of control buttons 22a-22n for controlling the operation of the cooking appliance are disposed on the control panel 20. A plurality of displays 24a-24n are disposed on the control panel 20 and each display 24a-24n is associated with a respective control button 22a-22n.

A processor 30 is associated with a data base 40. Data base 40 includes recipes for cooking food at the food cooking appliance associated with display panel 20. For the purposes of this application, a recipe corresponds to the time and temperature of operation of the food cooking appliance associated with a type and quantity of food. Processor 30 controls the cooking appliance to cook food in accordance with the recipe stored in data base 40. Each respective control button 22a-22n is assigned a recipe by processor 30 such that when a corresponding button 22a-22n is activated, a signal is sent to processor 30 to retrieve the associated recipe with the activated button and operate the cooking appliance in accordance with the recipe.

By way of example, control button 22a may correspond to a cooking of chicken, while control button 22b may correspond to french fries and so on through button 22n which corresponds to fried shrimp in the example of a fryer. To overcome the shortcomings of the prior art, processor 30 sends a display signal to control panel 20 which causes an indicator for each respective recipe associated with the respective button 22a-22n to be displayed at the respective associated display 24a-24n. Accordingly, in the exemplary embodiment discussed above, processor 30 causes “CHX” or “chicken” to be displayed in display 24a. Processor 30 causes “fries” or such other indicator to be displayed at display 24b and for “shrimp” to be displayed display 24n. These displays are displayed whether the corresponding button is selected, at all times, so long as the button is associated with the recipe.

An input/output device 50 communicates with processor 30 for providing instructions to processor 30. Instruction for input at input/output 50 may be for changing the association of control buttons 22a-22n with recipes 40 and operated upon by processor 30. In this way, control button 22a is manually changed to be associated with a recipe for cooking a filet of fish, rather than chicken, as shown in FIG. 2. Like numbers are utilized to indicate like structure in FIG. 2, the only difference being the indicator or label content “filet” displayed at display 24a where chicken was previously indicated.

It should be noted, that control panel 20 may be a physical panel having physical control buttons 22, each being associated with displays 24 such as LCD or LED displays within actual windows. For the purposes of this application, physical button is any button which has a structure for being contacted or depressed to initiate a signal, and does not include a virtual icon such as a graphical user interface To avoid confusion, in a preferred, but non-limiting embodiment, the buttons 22 are in physical proximity to the respective displays 24 so that it is readily apparent to the user which button corresponds to which display.

Additionally, processor 30 and data base 40 may be onboard constituent components, i.e. located within control panel 20 or incorporated into the food cooking appliance. However, processor 30 may also be remote, not incorporated with control panel 20 as part of a control system for controlling one or more cooking appliances within a facility. Furthermore, the input/output device may be any device capable of receiving information and inputting that information to processor 30. It may be a USB port, or it may be intranet, internet or a radio frequency communication modem allowing communication between an input device and the processor 30.

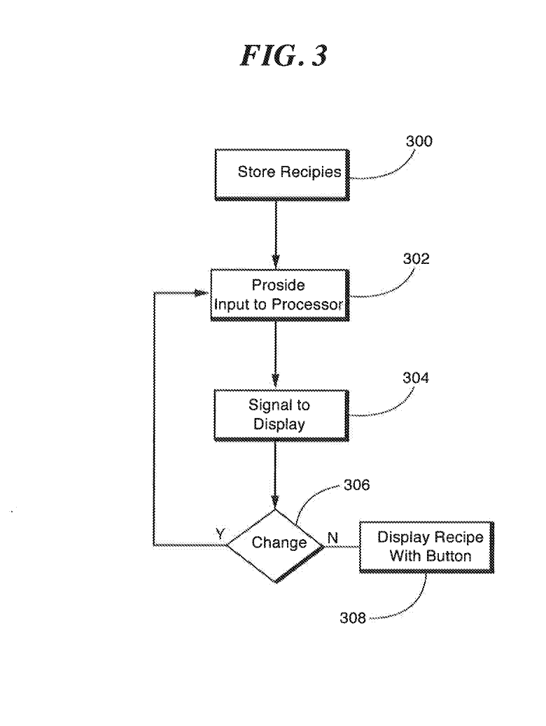

As shown in FIG. 3, during operation, recipes are stored in data base 40 in a step 300. The recipes may be stored in data base 40 as an original download or as input through input/output device 50. In a step 302, an input is provided to processor 30 through input/output device 50 to instruct processor 30 which recipes are to be associated with which control buttons 22a-22n. In step 304, processor 304 sends signals to respective displays 24a-24n to display a descriptor indicator of the food associated with the recipe corresponding to the respective control buttons 22a-22n. So by way of example, as shown in FIG. 1, processor 30 causes “chicken” to be displayed in display 24a when button 22a corresponds to the operation of the chicken cooking recipe. Similarly, a second display 24b may display “fries” by way of example as the recipe controlled by control button 22b as determined by processor 30 is for cooking fries. Lastly, processor 30 sends a signal to display 24n to display “shrimp” when a recipe for cooking shrimp is controlled by control button 22n.

The information within displays 24a-24n remain continuously displayed until the recipe associated with a control button 22a-22n is changed.

In a step 306, it is determined whether or not an instruction has been received from input/output device 50 to “reprogram” processor 30 by causing a change in a recipe associated with a control button 22. If yes, then the process is repeated by returning to step 302 where the input is provided to processor 30, which determines which recipe from data base 40 is to be associated with a respective control button 22 in accordance with the newly updated instructions from input/output device 50. Again in a step 304, processor 30 will cause the new information to be displayed at the appropriate displays 24a-24n. However, if it is determined that no change to the recipes associated with the control buttons 22 has been made, then in a step 308 the previously displayed information remains displayed within displays 24a-24n.

While this invention has been particularly shown and described to reference the preferred embodiments thereof, it would be understood by those skilled in the art that various changes in form and detail may be made therein without departing from the scope of the invention encompassed by the appended claims.

What is claimed as new and desired to be protected by Letters Patent of the United States is:

1. A programmable food cooking appliance having a display comprising:
a control panel, one or more control buttons for controlling operation of the food cooking appliance disposed on the control panel;
one or more displays, each one of the one or more displays being disposed on the display panel adjacent the control button;
a database for storing two or more recipes; and
a processor, the processor communicating with the database and assigning to a respective one of each control button, a recipe, and transmitting a display signal to the respective one of the displays adjacent to respective one control button, to display a description of the recipe associated with the respective control button.

2. The system of claim 1, further comprising an input/output device communicating with the processor for providing control signals for determining the recipe to be associated with the respective control button.

3. The programmable food cooking appliance of claim 1, wherein the control button is a physical button.

4. The programmable food cooking appliance of claim 1, wherein the display is one of an LED and LCD.

5. The programmable food cooking appliance of claim 1, wherein the control panel is a graphical user interface, and where each respective button is displayed on the control panel.

6. The programmable food cooking appliance of claim 5, wherein each respective display is displayed on the control panel.

7. A method for indicating a recipe associated with a control button of a food cooking appliance comprising the steps of:
providing one or more control buttons for controlling operation at the food cooking appliance on a control panel of the food cooking appliance;
providing one or more displays, each display being disposed on the display panel adjacent a respective control button;
storing two or more recipes in a database;
providing a processor communicating with the database and the control panel;
assigning a recipe to a control button; and
the processor sending a display signal to the display adjacent the control button and causing the display to display a description of the recipe associated with the respective control button.

8. The method of claim 7, wherein the control button is a physical button.

9. The programmable food cooking appliance of claim 7, wherein the display is one of an LED and LCD.

10. The method of claim 7, further comprising the step of inputting a change command to the processor;
the processor changing the recipe associated with at least one of the one or more control buttons; and
the processor sending a display signal to change the display at the display adjacent the respective one control button to display a description of the changed recipe associated with the respective control button.
